(19) United States
(12) Patent Application Publication
(10) Pub. No.: US 2016/0194498 A1
(43) Pub. Date: Jul. 7, 2016

(54) Heat Resistant Polymer Modified Asphalt Composition

(71) Applicants: Hari Chandra Chandrasekaran, Pepper Pike, OH (US); Chandrasekaran Ramayya Pillai, Pepper Pike, OH (US)

(72) Inventors: Hari Chandra Chandrasekaran, Pepper Pike, OH (US); Chandrasekaran Ramayya Pillai, Pepper Pike, OH (US)

(21) Appl. No.: 14/591,352

(22) Filed: Jan. 7, 2015

(51) Int. Cl. C08L 95/00; C08L 21/00; C08L 9/06

(52) U.S. Cl. CPC C08L 95/00; C08L 9/06; C08L 21/00; C08L 2205/03; C08L 2555/84

(57) ABSTRACT

This invention relates to an asphalt composition cured with non-free sulfur components that enhance its elastic properties and at the same time increases its resistance to degradation due to high heating for prolonged period as practiced in asphalt preparations for road pavement.

### UNITED STATES. PATENT DOCUMENTS

| | | |
|---|---|---|
| 5,256,710 | October 1993 | Krivohlavek |
| 5,750,598 | May 1998 | Krivohlavek |
| 6,569,925 | May 2003 | Baumgardner |

### BACKGROUND TO THE INVENTION

1. Field of this Invention

This invention relates to a non-free sulfur cured polymer modified asphalt composition comprising a polymer modified asphalt, a proprietary non-free sulfur curing agent and organic acid activator.

2. Description of Prior Art

Pavements are made with blends of asphalt and aggregate, typically in the ratio of 5 to 7% of asphalt in 93 to 95% of aggregate mixed at elevated temperatures ranging from 173° C. to as high as 250° C. or higher. In order to get the mix done at this high temperatures, the contractors generally have to get asphalt delivered to the construction site hot, heating from the time the asphalt is prepared ready for delivery to the site. It can take anywhere from 24 to 72 hours from the time the asphalt is warmed up to the time it is used at the construction site. This time period may even be longer if the asphalt were required to be polymer modified as the modification normally takes between one hour and 24 hours, depending on the type of polymer selected for the blend. In the process of heating the asphalt, especially the polymer modified version, the high heat tends to degrade the polymer and renders the desirable properties of the polymer ineffective. Hence there is a need for an additive or additives that would improve the heat resistance of the asphalt-both neat and polymer modified. We have perfected a system that would resist the heat degradation of asphalt. The system uses a proprietary vulcanizing additives product to cure the polymer modified asphalt. In asphalt, cure has traditionally been with elemental free sulfur. Free elemental sulfur does not contribute to resistance to heat aging of the asphalt. On the contrary free sulfur accelerates the heat aging of asphalt, and in particular the polymer that is present in polymer modified grades. In addition, free sulfur creates fire hazard which had resulted in many fire accidents in the past during the addition of sulfur to asphalt. Also, free sulfur addition results in objectionable odor from oxides of sulfur developed during the hot mixing process.

In the past many non-sulfur free cure systems were developed for use in curing asphalt. One of them is U.S. Pat. No. 5,256,710 issued on Oct. 26, 1993 to Dennis Krivohlavek that discloses a composition of phenolic or phenol-formaldehyde two-step resins either alone or in combination with each other for curing polymer modified asphalt. Also it discloses the mixture that may be used in combinations with elemental sulfur, as cross-linking or co- vulcanization catalysts or agents and (optionally) process oils to produce a product of enhanced performance suitable for commercial, construction and other industrial applications where asphalts or bitumen are to be used. It is different from the present invention in that it uses phenolic or phenol formaldehyde cure systems. In addition it also recommends its use with elemental sulfur both of which are not part of the cure components in the present invention. Nor is the phenol formaldehyde system disclosed in U.S. Pat. No. 5,256,710 has any claim with respect to improved resistance to heat aging and the ability to retain higher elastic properties.

One other patent awarded to Mr. Gayton L. Baumgardner et al, U.S. Pat. No. 6,569,925 issued on May 27, 2003 resembles some parts of the present invention in the components which are termed as accelerator-gel additives. The primary objective of that patent as spelt out under the title “Objects and Summary of the Invention” states that: “1) To provide a stable, composition for delivering accelerator into the liquid polymer-asphalt mixing during the production of polymer modified asphalt 2) To provide a stable accelerator-gel suspension that will not separate during storage or during manufacturing processes incorporating its use such as when added to the polymer asphalt system 3) To provide a stable accelerator-gel additive that may be premixed and stored at ambient temperature and is of a liquid or gel nature that offers ease of handling and pumpability under the normal processing conditions and at temperatures below 140°F.” That invention does not at any point claim to provide enhanced resistance to heat aging, nor retain the asphalt blend's elastic properties under long duration of heating at high temperatures. Furthermore, U.S. Pat. No. 6,569,925 characterizes sulfur as an accelerator, contrary to the claim it is sulfur free. Hence there is no relevance between the present invention and that of Mr. Gaylon's.

Other than that there are no other patents from our search having similar invention to address the problem of heat aging and retention of elastic properties. Therefore, there is a need for a solution to develop an asphalt composition with additives that confer heat resistance, and which at the same time cures the asphalt without elemental sulfur.

In the light of the problems associated with extensive heating of polymer modified asphalt during the preparation and subsequent storage and transportation at high temperatures to the road construction site, it is the objective of the present invention to provide a an asphalt composition that has chemical curatives without any elemental sulfur for the purpose of curing the asphalt.

It is another objective of this present invention to provide safe non-free sulfur preparation of asphalt composition that eliminates toxic fumes which is typical with addition of elemental sulfur to highly heated asphalt blends. In addition it is also another objective of the invention to provide an asphalt composition conferred with resistance to heat aging of the asphalt, and in particular the polymer present in the asphalt with elemental sulfur-free chemical for curing.

It is also a further objective of the invention to confer heat resistance to the asphalt/polymer blends in order to retain the elastic properties of the polymer in the blends, thus providing better service life of pavement under freeze and thaw conditions in cold weather.

### DETAILED DESCRIPTION OF THE INVENTION

The present invention is related to composition and preparation of a polymer modified asphalt blend with enhanced resistance to heat aging at elevated temperatures for extended length of time.

The composition comprises a polymer modified asphalt, a cure chemical made from reaction product of sulfenamides and inorganic oxides in combination with organic acids that together when heated in the polymer modified asphalt medium cross links the polymer and to certain extent the asphalt. This can be used in the normal course of blending polymer in asphalt and curing for road pavement, tack coat and chip seal applications. It is also useful in cross linking asphalt roofing insulation and road crack sealants to increase their service life.

The accelerator/organic oxide reaction product, a proprietary curative manufactured and sold under the name of “EcorCure” by Quantum Polymer Composites of Cleveland, Ohio comes in the form of thick paste which when warmed up turns to free flowing viscous liquid.

An activator may be added to increase the reaction of the curing agent “EcorCure.” The activators for the cure may be selected from the group comprising organic acids, namely Stearic Acid, Palmitic Acid, Oleic Acid and Linoleic Acid or combinations thereof. The organic acid activators may be in liquid, pastilles, flakes or pellets.

The polymer used in the polymer modification of the asphalt is devulcanized tire rubber manufactured and sold by Quantum Polymer Composites of Cleveland, Ohio. The devulcanized tire rubber is sold under the brand name of “ECORPHALT.” It is processed from rubber recovered from used tires. Hence it has some carbon black and other chemicals used in tire manufacture. ECORPHALT comes in the form of free flowing pellets. It is dissolved in asphalt using a high shear stirrer, and heated to around 173° C. for anywhere between 30 minutes and 6 hours depending on the source and grade of asphalt used. Besides ECORPHALT, other traditional polymers selected from the group comprising Natural Rubber (NR), Synthetic Polyisoprene rubber (IR), Styrene Butadiene Rubber (SBR), Butyl Rubber (BR or IIR for Isobutylene Isoprene Rubber), Styrene, Butadiene Styrene block copolymer (SBS), Styrene, Isoprene, Styrene Rubber (SIS), Styrene, Ethylene Butylene Styrene Rubber (SEBS), and Ethylene Propylene Diene Monomer or commonly known as EPDM Rubber or blends thereof.

The asphalt selected are from the group comprising asphalts derived from petroleum distillation process, naturally occurring asphalt, asphalt from various petroleum sources and blends thereof. The asphalt vary from source to source in their composition and their physical properties such as viscosity.

Finally the asphalt blend according to this invention is prepared by first selecting the asphalt, the polymer's, the ECORPHALT, the proprietary ECORCURE, Organic Acid/s, and then blending them in the following sequence to asphalt that is heated to around 173° C. while mixing using high shear stirrer.

First the selected polymer or polymers is added slowly over 5 to 10 minutes.

Next the mix is continued to be stirred for further 30 minutes before adding the organic acid, again slowly over a 3 to 5 minute period.

Followed by further stirring for additional 30 minutes before adding the ECORCURE which can be injected into the asphalt being stirred with no time lapse.

The mix is then continuously stirred for further 30 minutes to 4 hours. The mix is ready for use at the end of this process.

The resultant polymer modified asphalt cured with non-free sulfur vulcanizing composition, ECOCURE, exhibits high degree of resistance to heat aging and degradation relative to those cured with elemental sulfur.

The foregoing features and process techniques can be modified, combined or substituted by one skilled in the art. Hence it is intended that our claims to cover all additions, modifications, combinations and permutations.

The invention claimed is:

1. A process for manufacture of heat resistant polymer modified asphalt comprising the steps of:
a) providing a neat asphalt;
b) mixing slowly into the asphalt between 1.0% and 30% on the total weight of the mix a devulcanized rubber and/or a virgin polymer using a high or low shear stirrer at elevated temperature ranging from 150° C. to 250° C. for 30 minutes to 24 hours;
c) adding to the mix while continuing the stirring an organic acid in the amount of 0.1% to 5% on the weight of the total mix;
d) finally adding to the mix while continuing to stir a curing additive ECORCURE in the amount of 0.01% to 3% by weight on the total mix;
e) and further mixing for additional 60 minutes to 10 hours to obtain a high heat resistant polymer modified asphalt composition.

2. The process of claim 1 wherein the asphalt is from either Natural asphalt or asphalt from distillation process of crude petroleum having flash point of 325° C. and higher.

3. The process of claim 1 wherein the polymer is from the group consisting Devulcanized Tire Rubber manufactured and marketed by Quantum Polymer Composites of Cleveland, Ohio under the brand name of ECORPHALT, Styrene Butadiene Styrene block copolymer from Kraton Polymers of Houston, Texas sold under the brand name of KRATON, Styrene Butadiene Rubber, Natural Rubber, Styrene Isoprene Styrene rubber, Styrene Ethylene Butylene Styrene Rubber, and EPDM Rubber and mixtures thereof.

4. The process of claim 1 wherein the preferred polymer is ECORPHALT devulcanized Tire Rubber from Quantum Polymer in combination with Styrene Butadiene Styrene copolymer Kraton in the ratio of 3% to 12% ECORPHALT to 1% to 5% Kraton both on the total weight of the asphalt blend.

5. The process of claim 1 wherein the organic acid is from group consisting of Oleic Acid, Stearic Acid, Palmitic Acid, Linoleic Acid or mixtures thereof.

6. The process of claim 5 wherein the preferred organic acid is Stearic Acid.

7. The process of claim 1 wherein the curing agent is ECOCURE in the amount of 0.1% to 3.0%, preferably 0.5% on the total weight of the asphalt mix.

8. The process of claim 7 wherein the dosage of ECOCURE curing agent added to the mix is preferably in the amount of 0.2% to 1.2% on the total weight of the mix.

9. The process of claim 1 wherein the final mixing time after adding all of the components into the asphalt, is preferably 15 minutes to 60 minutes at elevated temperature of 150° C. to 185° C.

10. The process according to claim 1 further comprising a preliminary stage comprising the steps of:
a) mixing 1% to 5% epoxidized oil selected from the group of epoxidized oils of soybean, palm and other vegetable sources in 95% to 99% neat asphalt from petroleum fractionation process having a flash point of 325° C. minimum and viscosity at 60° C. of 750 to 1000 poise, at elevated temperature of 135° C. to 180° C. while stirring the mix using a low or high shear mixer for about 10 minutes to 30 minutes;
b) mixing slowly into the asphalt/epoxidized oil blend between 1.0% and 30% on the total weight of the mix, a devulcanized rubber and/or a virgin polymer using a high or low shear stirrer at elevated temperature ranging from 150° C. to 250° C. for 30 minutes to 24 hours;
c) adding to the mix while continuing the stirring an organic acid selected from the group comprising Stearic Acid, Oleic Acid, Palmitic Acid, Linoleic Acid and mixtures thereof in the amount of 0.1% to 5% on the Weight of the total mix;
d) finally adding to the mix while continuing to stir a curing additive ECORCURE in the amount of 0.01% to 3% by weight on the total mix;
e) and further mixing for additional 60 minutes to 10 hours to obtain a-high heat resistant polymer modified asphalt composition.
